(19) United States
(12) Patent Application Publication
(10) Pub. No.: US 2008/0286543 A1
(43) Pub. Date: Nov. 20, 2008

(54) Layered Sandwich Structure

(75) Inventor: Eric Metrot, Applecross (AU)

Correspondence Address: GREENBLUM & BERNSTEIN, P.L.C., 1950 ROLAND CLARKE PLACE, RESTON, VA, 20191, US

(73) Assignee: SALOMON S.A., Metz-Tessy (FR)

(21) Appl. No.: 12/091,244

(22) PCT Filed: Oct. 17, 2006
(86) PCT No.: PCT/FR06/02337

§ 371 Date: Apr. 23, 2008

(30) Foreign Application Priority Data
Oct. 24, 2005 (FR) 0510810

(51) Int. Cl. B32B 3/26; B32B 7/00; B32B 5/18; B29C 44/12; B29C 47/02; B29C 51/12

(52) U.S. Cl. 428/213; 428/304.4; 428/220; 428/316.6; 264/46.5

(57) ABSTRACT

The invention provides for a sandwich-type layered structure including at least one first core layer made of cellular material, a first reinforcing layer connected to a first surface of the first core layer, and a second reinforcing layer on the side connected to the second surface of the core layer, the layered structure including, between the first core layer and the first reinforcing layer, at least one compressed foam layer connected to these two layers.

### BACKGROUND OF THE INVENTION

1. Field of the Invention

The present invention relates to the field of sandwich-type layered structures, that is, structures comprising at least three superimposed layers of materials, one of the layers, called the core layer, comprising a (slightly compressible or incompressible) cellular material and being connected, on each of its surfaces, to a reinforcing material. These layers of material generally have one dimension (thickness) that is much smaller than their other dimensions, and the thickness of the reinforcing layers generally is at least 5 to 10 times smaller than the thickness of the core layer.

2. Description of Background and Other Information

In all the fields of application, the sandwich layered structures are appreciated for their very good weight to mechanical strength ratio, particularly with respect to their stiffness, or rigidity, in bending.

In a sandwich layered structure, the layers are connected to one another by any form of gluing, welding, etc., such that the bending of the structure translates into an essentially tensile or compressive stress of the (thin) reinforcing layers, the (thicker) core layer being essentially biased in compression in the depthwise direction, or in shearing in its general plane.

Thus, for the core layer, lightweight materials are generally used, which most often are cellular materials having an apparent density less than 400 kg/m³, and/or ligneous materials such as wood or other wood-base materials. These materials are generally substantially stiff, or rigid, in compression in the depthwise direction, at least with respect to the forces for which the structure is provided.

For the reinforcing layers, the composite materials comprised of fibers embedded in a plastic resin (whether the resin is thermoplastic or thermosetting) are appreciated for their mechanical properties and for their relative ease of implementation. However, other reinforcing materials, such as metals (especially aluminum), wood, or plastic materials with good mechanical properties, can be used.

Although a sandwich layered structure mainly comprises three layers connected to one another, they can comprise complementary layers, either in the form of outer layers superimposed on either of the reinforcing layers, or in the form of intermediary layers arranged between a reinforcing layer and the core layer. In this latter case, it is important to preserve a good connection between the various layers in order for the shearing forces to be transmitted from one layer to the other.

The invention can be applied to numerous industries, including marine engineering, aeronautics, railway construction, or car making. It can also be applied to the field of sports apparatuses, such as gliding apparatuses.

In spite of their very good intrinsic mechanical performance, the one with ordinary skill in the art always seek to improve the composite layered structures, in particular by attempting to optimize the mechanical performance to weight to cost ratio, especially in view of the specific constraints related to the production and to the use of gliding boards.

### SUMMARY OF THE INVENTION

To this end, the invention proposes a sandwich-type layered structure comprising at least one first core layer made of cellular material, a first reinforcing layer connected to a first surface of the first core layer, and a second reinforcing layer on the side connected to the second surface of the core layer, the layered structure comprises, between the first core layer and the first reinforcing layer, at least one compressed foam layer connected to these two layers.

### BRIEF DESCRIPTION OF THE DRAWINGS

Other characteristics and advantages of the invention will become apparent from the detailed description that follows, with reference to the annexed drawings, in which:

FIG. 1 is a schematic exploded perspective view of a sample sandwich structure according to a first embodiment of the invention.

FIG. 2 is a cross-sectional view of the sample of FIG. 1.

FIG. 3 is a view, similar to that of FIG. 1, illustrating a second embodiment of the invention.

FIG. 4 is a view, similar to that of FIG. 1, illustrating a third embodiment of the invention.

### DETAILED DESCRIPTION OF THE INVENTION

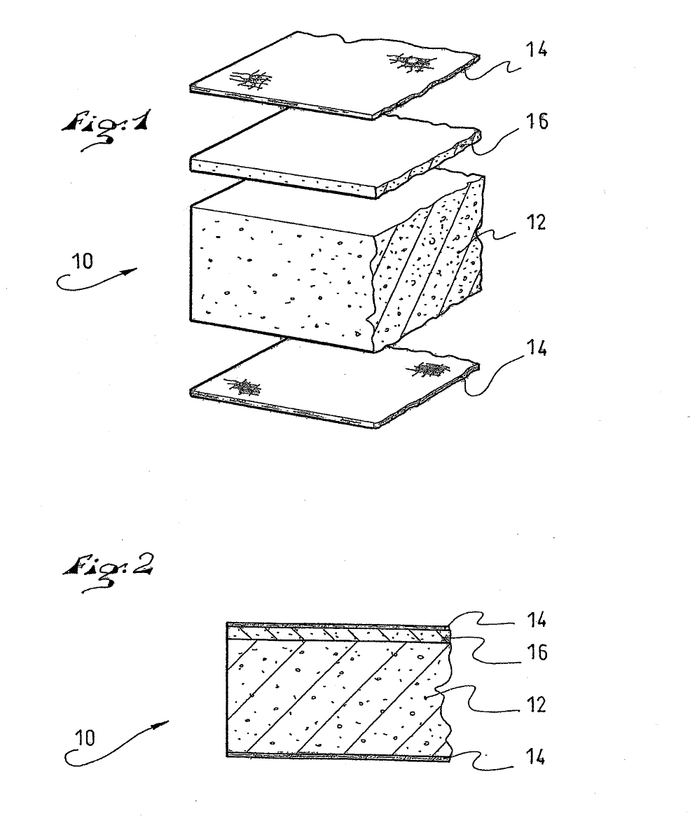

FIG. 1 is an exploded perspective view of a first example of a sandwich structure 10 according to the invention.

In the following description, the terms “upper”, “lower”, “top”, “bottom” are used with reference to the annexed drawings, and only to facilitate the understanding of the description, and are not limiting with respect to the scope of the invention.

This structure is here comprised of plate-shaped layers, in the sense that they have one dimension (their respective thicknesses) that is much smaller than their other two respective dimensions. These plates are essentially planar; but they could be curved into two or three dimensions, developable or nondevelopable in the mathematical sense.

The sandwich structure 10 therefore comprises a core layer 12 made of a cellular material on the two surfaces of which reinforcing layers 14 are arranged.

In the examples described hereinafter, the cellular material of the core layer 12 is selected from foams, especially the so-called rigid foams.

Indeed, one with ordinary skill in the art usually classifies foams made of plastic material into flexible foams, on the one hand, and into rigid foams, on the other hand. The rigid foams have low elasticity in the sense that as soon as the compression force exceeds a certain value, they collapsibly deform irreversibly or only slightly reversibly. The rigid foams include certain polyurethane foams, expanded polystyrene foams, and extruded polystyrene foams that are generally used in the form of foam cakes, or blocks, to form the cores of conventional surfboards. The so-called rigid foams also include certain PVC or polyimide foams that are generally used as the core in the sandwich structures.

Conversely, the expanded polyolefin foams, especially polypropylene foams, or even polyethylene foams, are generally considered by one with ordinary skill in the art as flexible foams, in particular due to their ability to undergo substantial elastic deformations.

In the examples more particularly under consideration, the material of the core 12 is an extruded polystyrene foam, such as that sold by The Dow Chemical Company under the trademark “Styrofoam” and with reference number “HD300”. This foam has a density of 45 kg/m³.

However, any other cellular material can be considered, especially any cellular material of less than 150 kg/m³, such as most foams made of plastic material.

The reinforcing layers 14 advantageously are layers of composite material, such as fibers (glass, carbon, aramid fibers, or mixtures thereof) impregnated with or embedded in resin (thermoplastic or thermosetting resin, for example, of the polyester or epoxy type). The fibers are preferably selected from woven long fibers, with the possibility to superimpose a plurality of fabrics (identical or different fabrics with various fiber orientations) within the same reinforcing layer 14.

According to the invention, the sandwich structure 10 comprises, between the core layer 12 and at least one of the reinforcing layers 14 (in this case, the upper reinforcing layer in the drawings), a compressed foam layer 16 that is directly or indirectly connected to these two layers 12, 14.

Compressed foam layer means a foam layer, especially made of plastic material, which has undergone compression with plastic deformation, thus going from a first stable state to a second stable state in which the material layer is permanently thinner than initially. As a result of this compression operation, the apparent density of the foam increases at a ratio that is substantially equivalent to that of the decrease in its thickness.

The compression operation is generally carried out prior to the assembly of the composite structure.

Preferably, this compression operation is thermocompression, meaning that it involves the addition of heat in order to bring the material into a state that promotes its plastic deformation ability.

In the case of an extruded polystyrene foam of the aforementioned type, it has been possible to compress foam plates until decreasing their thickness at a ratio of 2 to 12 times, preferably at least 4 times. For example, 4 mm plates were brought down to an average thickness of 0.5 mm, or a thickness reduction factor equal to 8, their apparent density then reaching approximately 360 kg/m³.

With other foams, or other compression rates, one can thus consider obtaining a compressed foam layer having a density between 150 and 500 kg/m³. Preferably, the thickness of the compressed foam layer is between 0.3 and 2 mm.

In the examples more particularly considered, a relatively uniform compression of the foam throughout its thickness has been sought. In particular, during the thermocompression operation, a substantially homogenous rise in the temperature of the material throughout the thickness of the plate has been sought. Thus, in order to compress 4 mm plates down to a thickness of about 0.5 mm, they were placed in a press at a temperature between 90 and 95° C. (or slightly above the vitreous transitional temperature of the material), at a pressure of 8 bars, for a period on the order of several minutes.

However, in certain cases, a non-homogeneous compression of the foam, the latter being, for example, more compressed in the vicinity of its upper and lower surfaces than in its center, can be sought. For this, it suffices, for example, to carry out the thermocompression with a minimal heating time prior to the compression phase itself, such that the temperature of the foam plate does not have time to homogenize in its thickness. Under the effect of pressure, the outermost portions of the plate can deform more easily than the core, and are therefore more compressed.

This thermoforming operation with plastic compression could also be carried out directly when the foam exits from the production line, for example by calendering directly upon exit from the extruding machine, in the case of an extruded foam.

The connection between the various layers of the sandwich structure (which is indispensable in order for the shearing stresses to be transmitted from one layer to another, and therefore in order for the structure to function as a sandwich structure rather than a mere stack) can be made in various ways, according to the procedures known to one with ordinary skill in the art for making sandwich structures.

First, the reinforcing layers, insofar as they are comprised of layers of resin-impregnated fibers, are connected to the core layer or to the compressed foam layer by said resin. In the case of reinforcing layers constituted of other materials, they can be connected to the adjacent layer by an appropriate glue.

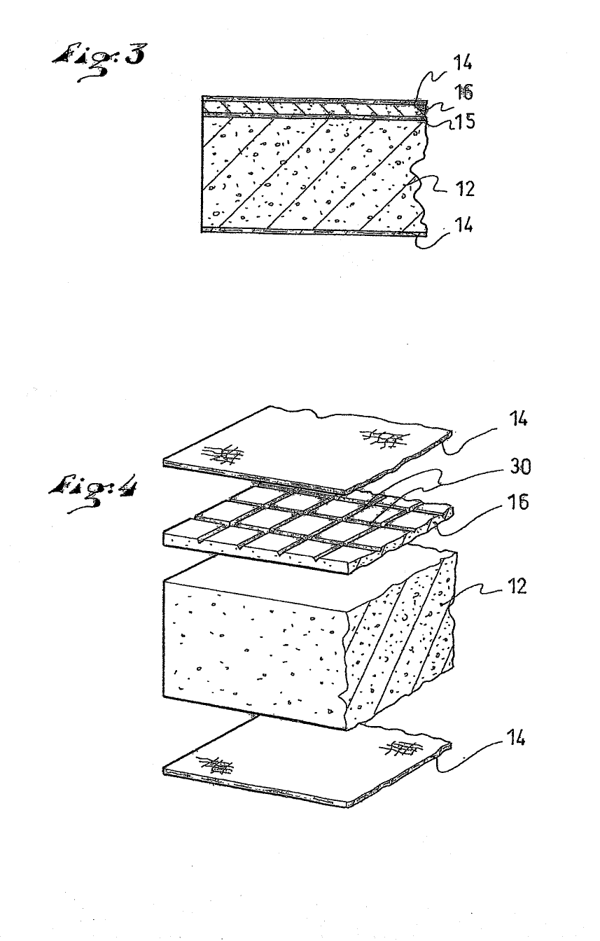

Next, with respect to the connection between the compressed foam layer and the core layer, one can first simply use gluing. This gluing can also be provided to be reinforced with woven or nonwoven, long or short fibers. This fiber-reinforced glue layer then forms an intercalary composite material layer 15 between the compressed foam layer 16 and the core layer 12, these two layers then being indirectly connected to one another by means of the intercalary layer 15, which is connected to both. Such an alternative embodiment is shown in FIG. 3. This intercalary layer 15 can be made in the form of a reinforcing layer, associating fibers and resin, for example, or in any other form of reinforcing layers as seen hereinabove.

The foam layer 16 thus compressed has the advantage of being highly resistant to any new compression stress along a perpendicular plane with respect to the structure. Therefore, it protects the core layer from this type of stress which can occur when, for example, the sandwich structure is biased in flexion. Indeed, in this case, the reinforcing layer 14 arranged on the inner flexion side (that whose concavity is increased) is compressively biased in its plane, and therefore can have a tendency to buckle inward, in the direction of the core layer 12. Because the latter is reinforced by the compressed foam layer 16, the reinforcing layer 14 is held better, and will buckle at more substantial stress ratios. Similarly, the structure is more resistant when a point pressure is applied perpendicularly to its reinforced surface. Naturally, these and other advantages will be obtained with more complex forces.

Preferably, the compressed foam layer has a thickness at least four times smaller than the thickness of the core layer. However, in order to prevent the weight of the compressed foam layer from overly increasing the weight of the structure, it is advantageous that the thickness ratio of the core layer to the compressed foam layer be even greater, at least 10, for example.

In the first two embodiments of the invention, the compressed foam layer is compressed so as to have substantially smooth upper and lower surfaces.

In another alternative embodiment of the invention, shown in FIG. 4, the sample only differs from the first in that, according to a second aspect of the invention, the compressed foam comprises etchings 30 on one of its surfaces (in this case on its upper surface turned toward the upper reinforcing layer 14).

Preferably, the etchings 30 are made without removal of material, simply by plastic compression of the lightweight material. They can thus be made by pressing a tool (for example, a plate or a roller provided with ribs) along a direction substantially perpendicular to the general plane of the lightweight layer, the tool leaving the imprint of its ribs after plastically compressing the material.

The etchings can be made before, during, or after compression of the foam.

Thus, in the case in which the foam is subject to thermocompression, one can provide for the etchings to be formed during this step, for example by inserting a flexible grid between the material and the mold or the (flexible or rigid) thermoforming press. The pressure applied to the material during this operation and the fact that it is brought to a temperature at which it is more plastic enable the grid to leave an imprint on the corresponding surface of the compressed foam layer.

By forming the etchings without removal of material, the risk of the etchings 30 becoming rupture zones in the lightweight material is reduced. Indeed, the material is neither destroyed, nor torn out in the area of the etchings made by plastic compression.

The etchings 30 can have diverse geometries. In cross section, for example, the etchings can have a V-shape, a shape with parallel sides and a rounded bottom, of a flare shape. Seen from the top, for example, they can be in the form of grooves (straight lines, curves, segments, etc.). They can form an ordered network (parallel and crisscrossed grooves arranged according to a particular symmetry, etc.) or a random network. Possibly, they can draw geometric figures, or even decorative patterns or textual elements.

In the example shown in FIG. 4, the etchings 30 form two networks that are crisscrossed with parallel lines drawing parallelogram cells (rhombi, rectangles, squares, etc.).

The etchings can have a depth on the order of 0.1 mm to 0.5 mm, or even more for relatively thick compressed foam layers. If need be, the depth of the etchings can be slightly less than the thickness of the compressed foam layer, for example on the order of 0.9 times the thickness. In this latter case, the etchings render the compressed foam layer particularly flexible and capable of assuming a complex, even nondevelopable three-dimensional shape.

According to one aspect of the invention, when the adjacent layer 14 is a composite layer, the etchings 30 are provided to be filled with the resin that forms the matrix of the composite material of the adjacent layer. In FIG. 4, this adjacent layer is the upper reinforcing layer 14. In this way, the composite material layer 14 has, on its surface interfacing with the compressed foam layer 16, projecting ribs whose shape directly complements the shape of the etchings 30 of the compressed foam layer 16.

Several embodiments are possible to ensure that the resin of the adjacent layer 14 penetrates inside the etchings 30. Indeed, one can use either plies of pre-impregnated fibers, or plies of dried fibers that are then impregnated with resin. In both cases, one can possibly provide to apply a first layer of resin prior to positioning the plies of (woven or nonwoven) fibers on the compressed foam layer 16, preferably before the first resin layer has completely polymerized, so as to ensure good cohesion between the first resin layer and the remainder of resin that impregnates the fibers.

Preferably, the resin that impregnates the fibers is polymerized under pressure, for example, by arranging the laminated structure in an enclosure having a flexible membrane, and by establishing a pressure differential between the inside and the outside of the enclosure, so that the flexible membrane presses the layer of fibers and of resin under polymerization closely against the compressed foam layer 16. The pressure differential can be obtained by creating a depression inside the enclosure, or by creating an excess pressure outside the enclosure. In this way, one ensures that the resin flows properly between the fibers and into the etchings 30 to form the ribs.

Furthermore, when the etchings are provided to be filled with resin, it is particularly important for the etchings not to be deep and wide; otherwise, it would take a large quantity of resin to fill up the etchings, which could considerably weigh down the structure.

The network of resin ribs thus created at the interface between the compressed foam layer 16 and the composite reinforcing layer 14 has numerous advantages. First, the presence of this network makes it possible to increase the contact surface between the two layers, therefore to increase the adhesion surfaces between the two layers, and therefore their cohesion, thus limiting the risk of delamination of the layers. This aspect is reinforced by the fact that the association of the ribs and complementary etchings provides a mechanical bond by complementarity of forms, which completes the chemical bond of the resin on the material of the compressed foam layer.

Second, the ribs make it possible to increase the mechanical performance of the structure, especially due to the fact that the composite layer is reinforced by the ribs and is particularly more resistant to buckling when the composite layer is compressively biased in its general plane, for example when the entire structure is biased in flexion. However, in the case of gliding boards, which most often are essentially biased in flexion (the front and rear ends being raised with respect to a central portion that is lowered, for example by the force of strong support), the flexing of the board translates, among other things, into a compressive bias of the upper surface of the board in its general plane. In this way, reinforcing the laminated structure according to the invention finds a particularly advantageous application for making the upper surfaces of the board, as shown in the examples below. In the example shown, the network of etchings 30 and of complementary ribs is a geometrically multidirectional and repetitive pattern. In this way, the reinforcing effect acts in a substantially homogenous manner in all directions. Naturally, with a more directional etching pattern, the reinforcing effect will also be more directional.

The principle of making a network of etchings, which has just been described when applied to one of the surfaces of the compressed foam layer, can also be applied to the other surface of the compressed foam layer 16 (the one that is turned toward the core layer 12), or even to one and/or the other of the surfaces of the core layer 12.

In an alternative embodiment, the etchings can be provided to be filled with a reinforcing frame, such that the latter is nested in the compressed foam layer. Thus, one can provide for the etchings to be made by pressing a grid (made of metal, fibers, etc.) into the surface of the compressed layer, and by leaving this grid in position in the compressed foam layer when the latter is integrated into the sandwich structure to be reinforced.

The previous embodiments have been described in the context of generally planar sandwich structures, but the invention can also be applied in the case of sandwich structures with more complex, especially three-dimensional geometries. Similarly, the sandwich structures according to the invention can comprise other additional elements, either in the area of the core layer (for example, reinforcing structures or multi-material cores), or in the area of the reinforcing layers (for example, additional protective layers or multi-material reinforcing layers, or possible intermediate layers).

In the two previous examples, the compressed foam layer has a substantially uniform density over its entire area (if not throughout its thickness). However, one could provide for the density of the layer not to be uniform but, for the foam layer, conversely, to have zones that are denser than others, these denser zones being arranged, for example, in zones that are subject to more substantial stresses. To this end, one can provide for the foam layer to be made in a plurality of juxtaposed elements, each having undergone different compression ratios, or being made, at a constant compression ratio, from foams having different initial densities. One could also provide to make a unitary multi-density layer. For this, one can start from an initial foam layer having a uniform density but a variable thickness. By subjecting the foam layer to thermocompression, during which its thickness is substantially evened up, the initially thicker zones would have undergone a greater compression ratio than the initially thinner zones, and therefore are denser.

In the previously described examples, the sandwich structure is reinforced on only one of its surfaces. This is valid more particularly for a structure that is asymmetrically biased. In this case, one preferably reinforces the side of the structure that is the most susceptible of being subject to compression forces perpendicular to the plane of the plates of the structure, and/or on the side of the structure for which the reinforcing layer is compressively biased in its plane. In the case of a structure biased more symmetrically, one can provide for it to be reinforced by a compressed foam layer on the two surfaces of its core, possibly with different compressed foam layers on each side.

1-15. (canceled)

16. A sandwich-type layered structure comprising:
at least one first core layer made of a cellular material;
a first reinforcement layer connected to a first surface of the first core layer;
a second reinforcement layer on a side connected to a second surface of the core layer;
between the first core layer and the first reinforcement layer, at least one compressed foam layer connected to the first core layer and the first reinforcement layer.

17. A layered structure according to claim 16, wherein:
the compressed foam layer is compressed by means of plastic deformation.

18. A layered structure according to claim 17, wherein:
the compressed foam layer has a compressed thickness of one-fourth or less of an uncompressed thickness.

19. A layered structure according to claim 16, wherein:
the compressed foam layer is compressed by means of plastic deformation by means of thermoforming.

20. A layered structure according to claim 16, wherein:
the compressed foam layer has a thickness at least four times smaller than a thickness of the core layer.

21. A layered structure according to claim 16, wherein:
the compressed foam layer has a thickness at least ten times smaller than a thickness of the core layer.

22. A layered structure according to claim 16, wherein:
the compressed foam layer has a thickness of between 0.3 mm and 2.0 mm.

23. A layered structure according to claim 16, wherein:
the compressed foam layer has an apparent density of between 150 kg/m³ and 500 kg/m³.

24. A layered structure according to claim 16, wherein:
the compressed foam layer comprises extruded polystyrene foam.

25. A layered structure according to claim 16, wherein:
an intercalary layer of composite material is positioned between the core layer and the compressed foam layer.

26. A layered structure according to claim 25, wherein:
the intercalary layer of composite material includes resin-coated fibers.

27. A layered structure according to claim 16, wherein:
the first reinforcement layer comprises a composite material including resin-coated fibers.

28. A layered structure according to claim 16, wherein:
the cellular material of the core layer has an apparent density less than 150 kg/m³.

29. A layered structure according to claim 28, wherein:
the cellular material of the core layer includes an extruded polystyrene foam.

30. A layered structure according to claim 16, wherein:
the reinforced foam layer comprises etchings.

31. A method of manufacturing a sandwich-type layered structure comprising:
connecting a first reinforcement layer connected to a first surface of at least one core layer, said core layer being made of a cellular material;
connecting a second reinforcement layer on a side connected to a second surface of the core layer;
compressing a layer of foam;
connecting said compressed layer of foam between the first core layer and the first reinforcement layer.

32. A method of manufacturing a sandwich-type layered structure according to claim 31, wherein:
the compressing a layer of foam comprises compressing the layer of foamed by means of plastic deformation.

33. A method of manufacturing a sandwich-type layered structure according to claim 32, wherein:
the compressing a layer of foam comprises compressing the layer of foam to a compressed thickness of one-fourth or less of an uncompressed thickness.

34. A method of manufacturing a sandwich-type layered structure according to claim 31, wherein:
the compressing a layer of foam comprises compressing the layer of foam by means of plastic deformation by means of thermoforming.

35. A method of manufacturing a sandwich-type layered structure according to claim 31, wherein:
the compressing a layer of foam comprises compressing a layer of foam to a thickness at least four times smaller than a thickness of the core layer.

36. A method of manufacturing a sandwich-type layered structure according to claim 31, wherein:
the compressing a layer of foam comprises compressing a layer of foam to a thickness at least ten times smaller than a thickness of the core layer.

37. A method of manufacturing a sandwich-type layered structure according to claim 31, further comprising:
compressing the layer of foam to a thickness of between 0.3 mm and 2.0 mm.

38. A method of manufacturing a sandwich-type layered structure according to claim 31, wherein:
the compressed foam layer has an apparent density of between 150 kg/m³ and 500 kg/m³.

39. A method of manufacturing a sandwich-type layered structure according to claim 31, wherein:
the compressed foam layer comprises extruded polystyrene foam.

40. A method of manufacturing a sandwich-type layered structure according to claim 31, further comprising:
positioning an intercalary layer of composite material between the core layer and the compressed foam layer.

41. A method of manufacturing a sandwich-type layered structure according to claim 40, wherein:
the intercalary layer of composite material includes resin-coated fibers.

42. A method of manufacturing a sandwich-type layered structure according to claim 31, wherein:
the first reinforcement layer comprises a composite material including resin-coated fibers.

43. A method of manufacturing a sandwich-type layered structure according to claim 31, wherein:
the cellular material of the core layer has an apparent density less than 150 kg/m³.

44. A method of manufacturing a sandwich-type layered structure according to claim 43, wherein:
the cellular material of the core layer includes an extruded polystyrene foam.

45. A method of manufacturing a sandwich-type layered structure according to claim 31, further comprising:
etching the reinforced foam layer.
